(19) United States
(12) Patent Application Publication
(10) Pub. No.: US 2012/0021913 A1
(43) Pub. Date: Jan. 26, 2012

(54) TURF SAFE GRANULAR HERBICIDE FORMULATIONS

(75) Inventors: John Robert James, Greensboro, NC (US); Johnny D. Reynolds, Greensboro, NC (US); James Alan Swanson, Greensboro, NC (US)

(73) Assignee: SYNGENTA CROP PROTECTION, LLC, Greensboro, NC (US)

(21) Appl. No.: 13/129,175

(22) PCT Filed: Nov. 12, 2009
(86) PCT No.: PCT/EP2009/008062

§ 371 Date: Oct. 10, 2011

Related U.S. Application Data
(60) Provisional application No. 61/114,587, filed on Nov. 14, 2008.

(51) Int. Cl. A01N 43/40; A01N 43/80; A01P 13/00; A01N 41/10

(52) U.S. Cl. 504/255; 504/348; 504/271

(57) ABSTRACT

The present invention relates to a method for controlling weeds in turfgrass without causing significant damage to the turfgrass, and a composition for the same.

The present invention relates to improved granule formulations for controlling weeds in turfgrass without causing significant damage to the turfgrass.

Selective herbicides are used to control weeds growing in turfgrass. However, certain herbicides, such as HPPD inhibiting herbicides, can cause injury to the turfgrass. Common phytotoxic effects include bleaching, stunting and reduced turfgrass quality. Phytotoxic effects can be particularly severe when herbicides are applied to warm and cool season turfgrass species.

As is well known in the art, there are numerous types of formulation. Granular formulations are particularly convenient for application to turfgrass since they can be quickly and easily distributed to large areas. Additionally, granule formulations of herbicides are desirable because they reduce foliar contact of the herbicide with turfgrass, and therefore can minimise turfgrass injury.

If turfgrass only sustains minor injury, it may recover with time. However, in some situations, such as on golf courses, where high quality turfgrass is essential, even a low level of phytotoxicity for a short time can be undesirable. Therefore, there exists a need to further reduce the injury sustained by turfgrass when applying selective herbicides, so that effective weed control can be achieved without causing unacceptable levels of turfgrass injury.

Surprisingly, it has been found that granular formulations of smectite clay are particularly useful for reducing herbicide phytotoxicity to turfgrass.

According to the present invention, there is provided a method for controlling weeds in turfgrass without causing significant damage to the turfgrass, comprising applying a herbicide as a granule formulation, wherein the granule formulation comprises smectite clay.

Smectite is a family of naturally occurring clay minerals, that includes montmorillonite, saponite, nontrite, hectorite and vermiculite. Smectites are known as expanding clays due to their “two is to one” structure that consists of two tetrahedral sheets sandwiching a central octahedral sheet, forming stacks of plate-shaped microscopic particles. In contrast, attapulgite (also known as palygorskite) and kaolinite clays have needle-like and layered sheet forms respectively.

Montmorillonite is hydrated sodium calcium aluminium magnesium silicate hydroxide having the formula (Na,Ca)_{0.33}(Al,Mg)₂(Si₄O₁₀)(OH)₂.nH₂O. Ion exchange and metal ion binding are possible with the charged faces and edges of sodium montmorillonite platelets.

The water content of smectite clays is variable. When water is absorbed, the microscopic particles tend to swell to several times their original volume, and therefore smectite clay is sometimes used as an additive to retain water in soils in drought prone situations. The smectite, sodium montmorillonite, is the main constituent in a volcanic ash called bentonite, which is used in drilling muds in the oil industry.

Any smectite clay may be used in accordance with the present invention. Suitably, the smectite is selected from the group consisting of montmorillonite, hectorite, saponite, nontrite, vermiculite, and mixtures thereof. In one embodiment, the smectite clay is montmorillonite.

The term ‘turfgrass’ as used herein refers to any grass species from the family Gramineae. For example the grass species may belong to the genera Agropyron, Agrostis, Axonopus, Bromus, Buchloë, Cynodon, Eremochloa, Festuca, Lolium, Paspalum, Pennisetum, Phleum, Poa, Stenotaphrum or Zoysia. Turfgrass may include more than one grass species.

The present invention can be practiced with all turfgrasses, including cool season turfgrass and warm season turfgrass.

Cool season turfgrasses include, for example: Bluegrasses (Poa L.), such as Kentucky Bluegrass (Poa pratensis L.), Rough Bluegrass (Poa trivialis L.), Canada Bluegrass (Poa compressa L.) and Annual Bluegrass (Poa annua L.); Bentgrasses (Agrostis L.), such as Creeping Bentgrass (Agrostis palustris Huds.), Colonial Bentgrass (Agrostis tenius Sibth.), Velvet Bentgrass (Agrostis canina L.) and Redtop (Agrostis alba L.); Fescues (Festuca L.), such as Creeping Red Fescue (Festuca rubra L.), Chewings Fescue (Festuca rubra var. commutate Gaud.), Sheep Fescue (Festuca ovina L.), Hard Fescue (Festuca longifolia), Tall Fescue (Festuca arundinacea Schreb.), Meadow Fescue (Festuca elatior L.); Ryegrasses (Lolium L.), such as Perennial Ryegrass (Lolium perenne L.), Annual (Italian) Ryegrass (Lolium multiflorum Lam.); Wheatgrasses (Agropyron Gaertn.), such as Fairway Wheatgrass (Agropyron cristatum (L.) Gaertn.), Western Wheatgrass (Agropyron smithii Rydb.); Smooth Brome (Bromus inermis Leyss.); and Timothy (Phleum L.).

Warm season turfgrasses include, for example Bermudagrasses (Cynodon spp.), Zoysiagrasses (Zoysia Willd.), St. Augustinegrass (Stenotaphrum secundatum (Walt.) Kuntze), Centipedegrass (Eremochloa ophiuroides (Munro.) Hack.), Carpetgrass (Axonopus Beauv.), Bahiagrass (Paspalum notatum Flugge.), Kikuyugrass (Pennisetum clandestinum Hochst. ex Chiov.), Buffalograss (Buchloe dactyloides (Nutt.) Engelm.), Centipedegrass (Eremochloa spp) and Seashore paspalum (Paspalum vaginatum swartz).

In one embodiment, the turfgrass is a warm season turfgrass. In a further embodiment, the turfgrass is a cool season turfgrass.

The present invention may be used in conjunction with any other crop, such as grass crops (cereals, rice, corn, sugarcane), ornamentals and row crops.

The present invention may be used in conjunction with any herbicide that is useful for controlling weeds growing in turfgrass. A complete list of all commercially available herbicides is available from the Pesticide Manual (published in 2006 by the British Crop Protection Council, 14^{th} edition). Suitable herbicides generally have activity against broadleaf weeds and/or grass weeds. The choice of herbicide to be used in any given situation depends on the weeds to be controlled, and turfgrass species.

Suitably the herbicide is hydrophobic and/or positively charged, to facilitate binding to the smectite clay.

In one embodiment, the herbicide is an HPPD inhibiting herbicide. HPPD inhibitors are herbicides that work by inhibiting the enzyme 4-hydroxyphenyl-pyruvate dioxygenase, and therefore disrupting catotenoid biosynthesis. Well known classes of HPPD inhibitors include triketones, isoxazoles and pyrazoles.

Suitably the HPPD inhibitor is a herbicide selected from the group consisting of mesotrione, sulcotrione, benoxfenap, isoxachlortole, isoxaflutole, pyrasulfotole, pyrazolynate, pyrazoxyfen, benzobicyclon, ketospiradox, tembotrione, tefuryltrione, topramezone, and a compound of formula I

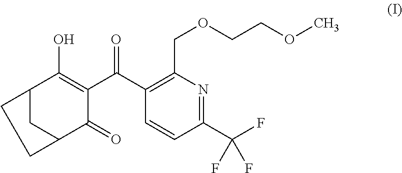

or a mixture thereof.

Any herbicidally active forms of the above compounds, such as salts, chelates and esters may be used in accordance with the present invention.

More suitably, the herbicide is selected from the group consisting of mesotrione, tembotrione, topramezone, a compound of formula I

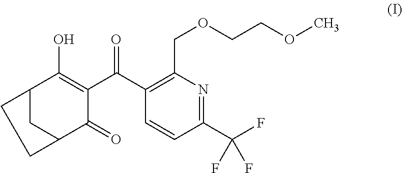

and a mixture thereof.

In one embodiment, the herbicide is mesotrione. In another embodiment, the herbicide is a compound of formula I.

According to the present invention, there is also provided a granular composition suitable for controlling weeds in turfgrass without causing significant damage to the turfgrass, comprising a herbicide and smectite clay. In one embodiment, the smectite clay is selected from the group consisting of montmorillonite, hectorite, saponite, nontrite, vermiculite, and mixtures thereof. Suitably, the smectite clay is montmorillonite.

In a further embodiment, the herbicide is an HPPD inhibiting herbicide, such as one selected from the group consisting of mesotrione, tembotrione, topramezone, a compound of formula I

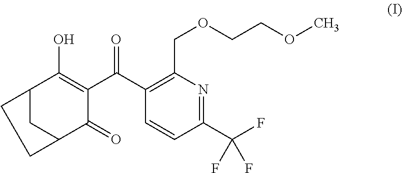

and a mixture thereof. Suitably, the herbicide is a compound formula I. Suitably, the herbicide is mesotrione.

Suitably, the smectite clay is montmorillonite, and the herbicide is a compound of formula I.

The present invention may be used to control a large number of agronomically important weeds, including monocotyledonous weeds and dicotyledonous weeds.

For example, the invention may be used to control dicotyledonous weeds such as Abutilon spp., Ambrosia spp., Amaranthus spp., Chenopodium spp., Cirsium spp., Euphorbia spp., Galium spp., Glechoma spp., Ipomoea spp., Lamium spp., Medicago spp., Polygonum spp., Sida spp., Sinapis spp., Solanum spp., Stellaria spp., Taraxacum spp., Trifolium spp., Veronica spp., Viola spp. and Xanthium spp.

The invention may also be used to control monocotyledonous weeds such as Agrostis spp., Alopecurus spp., Apera spp., Avena spp., Brachiaria spp., Bromus spp., Cynodon spp., Digitaria spp., Echinochloa spp., Eleusine spp., Eriochloa spp., Juncus spp., Kyllinga spp., Leptochloa spp., Lolium spp., Muhlenbergia spp., Ottochloa spp., Panicum spp., Paspalum spp., Phalaris spp., Poa spp., Rottboellia spp., Setaria spp., Sorghum spp., both intrinsically sensitive as well as resistant (e.g. ACCase and/or ALS resistant) biotypes of any of these grass weeds, as well as broadleaf monocotyledonous weeds such as Commelina spp., Monochoria spp., Sagittaria spp. and sedges such as Cyperus spp. and Scirpus spp.

In one embodiment of the present invention, the weeds are clover (Trifolium spp.) or dandelion (Taraxacum spp.). Surprisingly granular herbicide formulations containing smectite for use in the present invention, reduce herbicide phytotoxicity to turfgrass without significantly reducing efficacy of weed control. In particular, granular formulations comprising a compound of formula I for use in the present invention reduce herbicide phytotoxicity to turfgrass without significantly reducing efficacy of control of clover.

For the purposes of the present invention, the term ‘weeds’ includes undesirable crop species such as volunteer crops, both conventional and genetically altered, either by means of mutation or transgenic approaches. For example, in the context of turfgrass crops such as on a golf course, creeping bentgrass putting green turf can be considered a weed if found in a fairway or rough section where a different variety of grass is being cultivated.

The rate at which the granule formulation of the present invention is applied will depend upon the particular type of weed to be controlled, the species of turfgrass, the degree of control required and the timing of application. In general, the granule formulation can be applied at an application rate of from 0.001 kilograms active ingredient/hectare (kg ai/ha) to about 5.0 kg ai/ha, based on the total amount of active ingredient in the composition. Suitably, the application rate is from about 0.01 kg ai/ha to about 3.0 kg ai/ha, more suitably from about 0.05 kg ai/ha to 0.3 kg ai/ha.

The improvement in turfgrass safety provided by the present invention is particularly good when high rates of herbicide are applied to the turfgrass. Typically, an HPPD inhibiting herbicide such as mesotrione may be applied to turfgrass at a rate of between about 140 and 280 g ai/ha. Particularly good safening may be achieved at higher rates. Improved turf safety at high rates is critical to ensure that there is an adequate safety margin, for example when the product is applied at double the recommended rate due to an overlap in application by the lawn care operator.

The granular formulations for use in the present invention comprise smectite clay. The clay may be used in an unprocessed state, or it may be treated to enhance its absorptive properties or its resistance to attrition, for example by baking to reduce the volatile component.

Naturally occurring smectite clay typically comprises a mixture of more than one clay type. The smectite clay for use in the present invention may be a mixture of more than one clay type from the smectite class, for example containing montmorillonite and hectorite. Suitably, the granule formulation for use in the present invention comprises at least 20% by weight smectite clay. More suitably, the granule formulation for use in the present invention comprises at least 30% by weight smectite clay. More suitably, the granule formulation for use in the present invention comprises at least 40% by weight smectite clay. More suitably, the granule formulation for use in the present invention comprises at least 50% by weight smectite clay. More suitably, the granule formulation for use in the present invention comprises at least 60% by weight smectite clay. More suitably, the granule formulation for use in the present invention comprises at least 70% by weight smectite clay. More suitably, the granule formulation for use in the present invention comprises at least 80% by weight smectite clay. More suitably, the granule formulation for use in the present invention comprises at least 90% by weight smectite clay. More suitably, the granule formulation for use in the present invention comprises at least 95% by weight smectite clay. More suitably the granule formulation for use in the present invention consists essentially of smectite clay.

In addition to smectite clay, the granular formulations for use in the present invention may contain other carriers, such as fertiliser, sand, limestone, fuller's earth, attapulgite clay, bentonite clays, perlite, calcium carbonate, brick, pumice, pyrophyllite, kaolin, dolomite, plaster, wood flour, ground corn cobs, ground peanut hulls, sugars, sodium chloride, sodium sulphate, sodium silicate, sodium borate, magnesia, mica, iron oxide, zinc oxide, titanium oxide, antimony oxide, cryolite, gypsum, chalk, zeolite, calcite, diatomaceous earth, calcium sulphate and other organic or inorganic materials which absorb, or which can be coated with, a pesticide. Suitably, the granular formulations for use in the present invention comprise mainly montmorillonite clay. In one embodiment, the granular formulations for use in the present invention consist essentially of montmorillonite clay.

Optionally, the granular formulation includes a fertiliser material such as urea/formaldehyde fertilisers, urea, potassium compounds (such as potassium sulphate, nitrate, chloride, oxide, metaphosphate), ammonium compounds (such as ammonium nitrate, sulphate, phosphate), phosphorus compounds (such as phosphoric acid), sulphur, similar plant nutrients and micronutrients and mixtures or combinations thereof.

Granular formulations for use in the present invention include both extrudates and relatively coarse particles. In addition to the pesticide and carrier, generally, the granules can include surface active agents (which term can include dispersants and wetting agents) and auxiliary agents such as binders, stabilizers and buffering agents. The granule components preferably should not degrade the pesticidally active material during the granule preparation or on long term storage or use in the field. Those of skill in the art can readily select appropriate granule components to satisfy these criteria.

The pesticide may be homogeneously distributed throughout the granule, spray impregnated or absorbed onto the granule substrate after the granules are formed, or coated onto the surface of the granule. If the pesticide is impregnated or absorbed onto a pre-formed granule substrate, the pesticide is suitably dissolved in a solvent and applied to the granule as a liquid formulation.

A binder may be used to agglomerate the components of the granules. When present, the binder can be typically used in amounts up to about 20 percent by weight (dry basis) of the granular composition, more typically between about 2 to about 20 percent by weight. The binder binds the ingredients into a granular substrate which resists attrition and will not rapidly degrade, and therefore substantially maintains particle size during handling. Examples of suitable binders include brewers condensed solubles, lignosulfonate, sodium carbonate lignin, cane molasses, beet syrup, beet molasses, desugared beet molasses, whey, starch, soy solubles with cane molasses or the like, hydrolyzed collagen, amino acid solutions, cellulose derivatives, or cellulose based polymer binders. Other water soluble binders having equivalent properties to, for example, brewer's condensed solubles, can also be used.

Additional auxiliary agents such as surfactants, dispersants, disintegrating agents, wetting agents and the like, can be added where desired to modify the properties of the granules.

Granular formulations of the present invention may contain from about 0.01% to about 99% herbicide by weight. Suitably, the granule formulations contain from about 0.01% to about 10% herbicide by weight. More suitably, the granule formulations contain from about 0.01% to about 1% herbicide by weight. More suitably, the granule formulations contain from about 0.05% to about 0.5% herbicide by weight.

Additional active ingredients may also be present in the formulations, including surface-active agents such as heavy aromatic naphthas, kerosene and other petroleum fractions, or vegetable oils; and/or stickers such as dextrins, glue or synthetic resins.

The method of the present invention also extends to multiple treatments of turfgrass, with several days or weeks between treatments.

Simultaneous treatment of turfgrass with herbicide to control weeds, and fertiliser to enhance turfgrass growth, is desirable since this is cost and time efficient. Suitably, the granule formulation comprising smectite clay that is used in the present invention, further comprises fertiliser as described above. Alternatively, the smectite clay based granules containing herbicide may be blended with fertiliser granules, for co-application.

According to the present invention, there is also provided a method for controlling weeds in turfgrass without causing significant damage to the turfgrass, comprising applying a first granule formulation comprising a herbicide, and a second granule formulation comprising a fertiliser, wherein the first granule formulation comprises smectite clay.

The method of the present invention may be used to control weeds pre- or post-emergence of either the weeds, or the turfgrass.

### EXAMPLES

Granule treatments were prepared according to the table below. Treatments 1 to 14 were prepared by applying a compound of formula I in a propylene carbonate solution, to the exterior of a pre-formed granule. Treatments 15 and 16 were prepared by making a homogeneous mixture of starch, wetting agent, absorptive material, propylene carbonate and formula I, and extruding the mixture to form granules.

TABLE 1
Treatments

| | | Target | |
|---|---|---|---|
| | | % of | |
| Treatment | Granule type | formula I | Granule type |
| 1 | Cellulose | 0.14 | Bio Dac |
| 2 | Cellulose | 0.14 | DG Lite |
| 3 | Cellulose | 0.14 | Eco Gran |
| 4 | Cellulose | 0.08 | Eco Gran |
| 5 | Cellulose | 0.08 | Eco Gran with 5% agnique |
| | | | ME 181 |
| 6 | Cellulose | 0.14 | DG Lite with cyprosulfamide |
| | | | 25 WP |
| 7 | Cellulose | 0.14 | DG Lite with Isoxadifen-ethyl |
| | | | 25 WP |
| 8 | Clay (attapulgite) | 0.14 | Agsorb 16/30 RVM (GA) |
| 9 | Clay (attapulgite) | 0.14 | Agsorb 18/40 LVM (GA) |
| 10 | Clay | 0.14 | Agsorb 12/24 LVM (MS) |
| | (montmorillonite) | | |
| 11 | Clay | 0.14 | Disintegrating engineered |
| | (montmorillonite) | | granule (0.9-1.7 mm) |
| 12 | Clay | 0.08 | Disintegrating engineered |
| | (montmorillonite) | | granule (0.9-1.7 mm) |
| 13 | Clay | 0.08 | Disintegrating engineered |
| | (montmorillonite) | | granule (0.9-1.7 mm) with |
| | | | agnique ME 181 |
| 14 | Clay | 0.08 | Disintegrating engineered |
| | (montmorillonite) | | granule (0.9-1.7 mm) with |
| | | | sunspray oil |
| 15 | Starch | 0.14 | Non-dispersing extruded |
| | | | granules |
| 16 | Starch | 0.14 | Non dispersing extruded |
| | | | granules with agnique |
| | | | ME 181 |
| 17 | CONTROL | n/a | n/a |
| | (spray | | |
| | formulation) | | |
| 18 | CONTROL | n/a | n/a |
| | (untreated) | | |

### Example 1

### Phytotoxicity Against Warm and Cool Season Turfgrasses

The granule formulations were applied to perennial ryegrass, tall fescue, and St. Augustinegrass, growing at Vero Beach in Florida. Assessments for percentage bleaching and percentage stunting were made at regular timepoints. The results are presented in the table below. Note that only the first assessment for percentage bleaching is presented, because the turfgrass recovered about 2 weeks after treatment, and therefore no significant difference in bleaching was observed between treatments at later timepoints. No stunting was observed for any of the treatments.

TABLE 2
Percentage bleaching of granule formulations

| | Perennial | | | | | |
|---|---|---|---|---|---|---|
| | Ryegrass* | | Tall fescue** | | St. Augustinegrass*** | |
| | | % | | % | | % |
| Treat- | Rate | bleaching | Rate | bleaching | Rate | bleaching |
| ment | (g ai/ha) | (8 DAT^{#}) | (g ai/ha) | (8 DAT) | (g ai/ha) | (11 DAT) |
| 1 | 520 | 13.3 | 680 | 13.8 | 360 | 20.0 |
| 2 | 520 | 18.8 | 680 | 20.0 | 360 | 20.0 |
| 3 | 520 | 18.8 | 680 | 20.0 | 360 | 23.8 |
| 4 | 520 | 20.0 | 680 | 16.3 | 360 | 27.5 |
| 5 | 520 | 20.0 | 680 | 21.3 | 360 | 25.0 |
| 6 | 520 | 21.3 | 680 | 22.5 | 360 | 15.0 |
| 7 | 520 | 21.3 | 680 | 21.3 | 360 | 21.3 |
| 8 | 520 | 18.8 | 680 | 18.8 | 360 | 22.5 |
| 9 | 520 | 20.0 | 680 | 23.8 | 360 | 22.5 |
| 10 | 520 | 5.8 | 680 | 9.3 | 360 | 15.0 |
| 11 | 520 | 6.3 | 680 | 12.5 | 360 | 12.5 |
| 12 | 520 | 7.0 | 680 | 6.3 | 360 | 8.8 |
| 13 | 520 | 2.8 | 680 | 10.0 | 360 | 7.5 |
| 14 | 520 | 2.8 | 680 | 6.0 | 360 | 6.3 |
| 15 | 520 | 23.8 | 680 | 20.0 | 360 | 20.0 |
| 16 | 520 | 18.8 | 680 | 21.3 | 360 | 23.8 |
| 17 | 260 | 31.3 | 340 | 18.8 | 180 | 30.0 |
| 18 | 0 | 0.0 | 0 | 8.8 | 0 | 0.0 |

*Lolium perenne (LOLPE), blend of varieties
**Festuca arundinacea (FESAR), variety Coronado
***Stenotaphrum secundatum (STPSE), variety Floratam
^{#}DAT = days after treatment

The data shows that treatment of turfgrass with montmorillonite clay granule based formulations (treatments 10 to 14) resulted in less bleaching than other granule types, for all turfgrass species tested. Treatments 13 and 14 (montmorillonite clay granule formulations with agnique ME 181, or sunspray oil) gave particularly good results. Treatment 17 shows that a spray formulation of the same herbicide applied at half the rate of the granule formulations caused much more bleaching.

### Example 2

### Phytotoxicity Against St. Augustinegrass and Weed Control of Clover

A selection of the treatments used in Example 1 were identified for further testing, as indicated in the table below. In this trial, percentage bleaching of St. Augstinegrass, and percentage control of clover (Trifolium spp.) were assessed. For clarity, the treatment numbers used in Example 1 trial have been retained.

TABLE 3
Control of clover in St. Augustinegrass (v Floratam)

| | Rate (g | % bleaching | | % weed control | |
|---|---|---|---|---|---|
| Treatment | ai/ha) | 10 DAT | 13 DAT | 10 DAT | 13 DAT |
| 2 | 140 | 10.0 | 20.0 | 75.0 | 85.0 |
| 10 | 140 | 10.0 | 20.0 | 70.0 | 75.0 |
| 11 | 140 | 10.0 | 20.0 | 70.0 | 80.0 |
| 12 | 140 | 10.0 | 20.0 | 75.0 | 90.0 |
| 13 | 140 | 8.0 | 12.0 | 65.0 | 70.0 |
| 14 | 140 | 5.0 | 12.0 | 65.0 | 75.0 |
| 17 | 140 | 35.0 | 60.0 | 85.0 | 95.0 |
| 18 | 0 | 0.0 | 0.0 | 0.0 | 0.0 |

The results show that the montmorillonite clay granule formulations (treatments 10-14) caused the same or less bleaching than the DG Lite based formulation (treatment 2), with only slight or no reduction in percentage control of clover.

### Example 3

### Phytotoxicity Against St. Augustinegrass and Weed Control of Dollarweed

A selection of the treatments used in Example 1 were identified for further testing, as indicated in the table below. In this trial, percentage bleaching of St. Augstinegrass, and percentage control of dollarweed (Hydrocotyle spp.) were assessed. For clarity, the treatment numbers used in Example 1 trial have been retained.

TABLE 4
Control of dollarweed in St. Augustinegrass (v Delmar)

| | Rate (g | % bleaching | | % weed control | |
|---|---|---|---|---|---|
| Treatment | ai/ha) | 10 DAT | 14 DAT | 10 DAT | 14 DAT |
| 2 | 240 | 2.7 | 14.5 | 55.0 | 63.3 |
| 10 | 240 | 6.7 | 8.3 | 23.3 | 53.3 |
| 11 | 240 | 2.3 | 8.3 | 23.3 | 55.0 |
| 12 | 240 | 4.0 | 6.3 | 23.3 | 51.7 |
| 13 | 240 | 3.3 | 5.0 | 15.0 | 38.3 |
| 14 | 240 | 3.3 | 6.0 | 25.0 | 51.7 |
| 17 | 240 | 30.0 | 46.7 | 70.0 | 80.0 |
| 18 | 0 | 0.0 | 0.0 | 15. | 0.0 |

The results show that at 14 days after treatment, montmorillonite clay granule formulations (treatments 10-14) caused less bleaching than the DG Lite based formulation (treatment 2), with only a slight reduction in percentage control of dollarweed.

### Example 4

### Weed Control of Bull Paspalum, Globe Sedge and Thistle

A selection of the treatments used in Example 1 were identified for further testing, as indicated in the table below. In this trial, weed control of bull paspalum (Paspalum boscianum), globe sedge (Cyperus globulosus) and thistle (Cirsium spp.) was assessed at 12 and 22 days after treatment. For clarity, the treatment numbers used in Example 1 trial have been retained.

TABLE 5
Control of bull paspalum, globe sedge and thistle

| | | Bull paspalum* | | Globe sedge** | | Thistle*** | |
|---|---|---|---|---|---|---|---|
| Treat- | Rate | 12 | 22 | 12 | 22 | 12 | 22 |
| ment | (g ai/ha) | DAT | DAT | DAT | DAT | DAT | DAT |
| 2 | 240 | 43.3 | 36.7 | 36.7 | 45.0 | 95.0 | 96.7 |
| 10 | 240 | 30.0 | 41.7 | 23.3 | 41.7 | 95.0 | 98.3 |
| 11 | 240 | 21.7 | 33.3 | 20.0 | 38.3 | 91.7 | 93.3 |
| 12 | 240 | 25.0 | 38.3 | 26.7 | 33.3 | 100.0 | 100.0 |
| 13 | 240 | 21.7 | 40.0 | 21.7 | 45.0 | 90.0 | 93.3 |
| 14 | 240 | 23.3 | 38.3 | 15.0 | 40.0 | 95.0 | 93.3 |
| 17 | 240 | 76.7 | 85.0 | 63.3 | 71.7 | 100.0 | 100.0 |
| 18 | 0 | 0.0 | 0.0 | 0.0 | 0.0 | 0.0 | 0.0 |

*Paspalum boscianum (PASBO)
**Cyperus globulosus (CYPGL)
***Cirsium spp. (CIRSS)

The results show that at 22 DAT no significant reduction in weed control was observed between treatment 2 (DG Lite based granules) and treatments 10-14 (montmorillonite clay based granules).

### Example 5

### Phytotoxicity of Granule Formulations Against Fine Fescue

A selection of the treatments used in Example 1 were identified for further testing, as indicated in the table below. In this trial, percentage bleaching of Chewings Fescue ('Festuca rubra var. commutata Gaud.) was assessed for 4 granule treatments, each applied at 2 different herbicide rates. For clarity, the treatment numbers used in Example 1 trial have been retained.

TABLE 6
Phytotoxicity of granule formulations against fine fescue

% bleaching

| Treatment | Rate (g ai/ha) | 15 DAT | 25 DAT |
|---|---|---|---|
| 2 | 140 | 6.7 | 10.0 |
| 10 | 140 | 3.0 | 4.0 |
| 12 | 140 | 3.0 | 4.7 |
| 13 | 140 | 3.0 | 5.7 |
| 2 | 420 | 23.3 | 28.3 |
| 10 | 420 | 8.3 | 25.0 |
| 12 | 420 | 4.0 | 11.7 |
| 13 | 420 | 1.3 | 13.3 |
| 17 | 140 | 4.0 | 0.7 |
| 18 | 0 | 0.0 | 0.0 |

The data shows that at both rates and both timepoints, the montmorillonite clay granules results in less bleaching of fine fescue than DG Lite granules.

### Example 6

### Phytotoxicity of Granule Formulations Against Perennial Ryegrass

A selection of the treatments used in Example 1 were identified for further testing, as indicated in the table below. In this trial, percentage bleaching of perennial ryegrass (Lolium perenne) was assessed for 4 granule treatments, each applied at 2 different herbicide rates. For clarity, the treatment numbers used in Example 1 trial have been retained.

TABLE 7
Phytotoxicity of granule formulations against perennial ryegrass

% bleaching

| Treatment | Rate (g ai/ha) | 15 DAT | 25 DAT |
|---|---|---|---|
| 2 | 140 | 1.3 | 2.0 |
| 10 | 140 | 5.7 | 2.3 |
| 12 | 140 | 3.0 | 3.0 |
| 13 | 140 | 2.3 | 1.7 |
| 2 | 420 | 3.3 | 1.3 |
| 10 | 420 | 1.7 | 4.0 |
| 12 | 420 | 1.3 | 2.3 |
| 13 | 420 | 1.7 | 1.3 |
| 17 | 140 | 4.0 | 0.7 |
| 18 | 0 | 0.0 | 0.0 |

The data shows that, at 15 DAT at higher rates, the montmorillonite clay granules (treatments 10-13) resulted in less bleaching of perennial ryegrass than DG Lite granules (treatment 2).

### Example 7

### Phytotoxicity Against Perennial Ryegrass and Weed Control of Dandelion

A selection of the treatments used in Example 1 were identified for further testing, as indicated in the table below. In this trial, conducted in Wisconsin, percentage bleaching of perennial ryegrass (Lolium perenne), and percentage control of dandelion (Taraxacum officinale) were assessed for 4 granule treatments, each applied twice at 2 different herbicide rates. For clarity, the treatment numbers used in Example 1 trial have been retained.

TABLE 8
Control of dandelion in perennial ryegrass

| | Rate (g | % bleaching | % weed control |
|---|---|---|---|
| Treatment | ai/ha) | 13 DAT-2* | 13 DAT-2 |
| 2 | 140 | 11.7 | 100.0 |
| 10 | 140 | 1.7 | 100.0 |
| 12 | 140 | 0.0 | 94.0 |
| 13 | 140 | 0.0 | 86.0 |
| 2 | 420 | 26.7 | 100.0 |
| 10 | 420 | 13.3 | 100.0 |
| 12 | 420 | 10.0 | 100.0 |
| 13 | 420 | 5.0 | 100.0 |
| 17 | 140 | 43.3 | 100.0 |
| 18 | 0 | 0.0 | 0.0 |

*DAT-2 = days after second treatment

The data show that, at 13 DAT-2, the montmorillonite clay granules (treatments 10-13) resulted in less bleaching of perennial ryegrass than DG Lite granules (treatment 2) applied at either rate with little to no reduction in dandelion control.

1. A method for controlling weeds in turfgrass without causing significant damage to the turfgrass, comprising applying a herbicide as a granule formulation, wherein the granule formulation comprises smectite clay.

2. A method according to claim 1, wherein the smectite clay is selected from the group consisting of montmorillonite, hectorite, saponite, nontrite, vermiculite, and mixtures thereof.

3. A method according to claim 2, wherein the smectite clay is montmorillonite.

4. A method according to claim 1, wherein the turfgrass is a cool-season turfgrass.

5. A method according to claim 1, wherein the herbicide is an HPPD inhibiting herbicide.

6. A method according to claim 5, wherein the herbicide is selected from the group consisting of mesotrione, tembotrione, topramezone, a compound of formula I 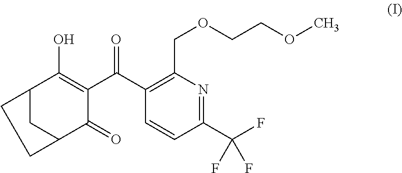
and a mixture thereof.

7. A method according to claim 6, wherein the herbicide is a compound of formula I.

8. A method according to claim 6, wherein the herbicide is mesotrione.

9. A method according to claim 1, wherein the weeds are clover or dandelion.

10. A method according to claim 1, wherein the granule formulation further comprises fertiliser.

11. A method for controlling weeds in turfgrass without causing significant damage to the turfgrass, comprising applying a first granule formulation comprising a herbicide, and a second granule formulation comprising a fertiliser, wherein the first granule formulation comprises montmorillonite clay.

12. A granular composition suitable for controlling weeds in turfgrass without causing significant damage to the turfgrass, comprising a herbicide and smectite clay.

13. A granular composition according to claim 12, wherein the smectite clay is selected from the group consisting of montmorillonite, hectorite, saponite, nontrite, vermiculite, and mixtures thereof.

14. A granular composition according to claim 13, wherein the smectite clay is montmorillonite.

15. A granular composition according to claim 12, wherein the herbicide is an HPPD inhibiting herbicide.

16. A granular composition according to claim 15, wherein the herbicide is selected from the group consisting of mesotrione, tembotrione, topramezone, a compound of formula I 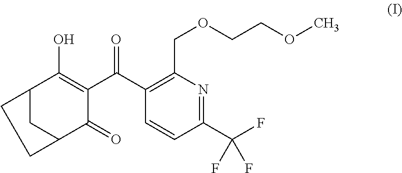
and a mixture thereof.

17. A granular composition according to claim 16, wherein the herbicide is a compound of formula I.

18. A granular composition according to claim 16, wherein the herbicide is mesotrione.
